(19) United States
(12) Patent Application Publication
(10) Pub. No.: US 2015/0127366 A1
(43) Pub. Date: May 7, 2015

(54) SYSTEMS AND METHODS FOR MANAGEMENT INFORMATION UPDATE BASED ON PROCEDURE PREFERENCE INFORMATION

(71) Applicant: Virtual Preference Management, Inc., Durham, NC (US)

(72) Inventors: William Fathy ElLaissi, Raleigh, NC (US); Charles Smith, Lilburn, GA (US); Alex Cho, Durham, NC (US)

(21) Appl. No.: 14/531,092

(22) Filed: Nov. 3, 2014

Related U.S. Application Data
(60) Provisional application No. 61/898,566, filed on Nov. 1, 2013.

(51) Int. Cl. G06F 19/00

(52) U.S. Cl. CPC G06F 19/327
USPC 705/2

(57) ABSTRACT

Systems and methods for management information update based on procedure preference information are disclosed. According to an aspect, a method includes receiving procedure preference information and an associated identifier of a user. The method also includes updating management information for a procedure associated with the identifier of the user based on the procedure preference information.

### CROSS REFERENCE TO RELATED APPLICATION

This application claims priority to U.S. Provisional Patent Application No. 61/898,566, filed Nov. 1, 2013 and titled SYSTEMS AND METHODS FOR MANAGEMENT INFORMATION UPDATE BASED ON PROCEDURE PREFERENCE INFORMATION, the disclosure of which is incorporated herein by reference in its entirety.

### TECHNICAL FIELD

The present subject matter relates to procedure management. Particularly, the present subject matter relates to update of management information based on procedure preference information.

### BACKGROUND

Management of surgical preferences of physicians and other healthcare personnel poses significant challenges to hospitals and health systems. Surgeon preference cards have been used to indicate instruments, implants, supplies, equipment, instructions, and/or drugs preferred by each physician for specific surgical procedures. In addition, preference cards can provide data to track costs associated with each procedure and patient charges. A nurse or other healthcare personnel may be responsible for creating and managing the preference card process. In many cases, preference cards can become outdated, and there may not be a suitable method in place for card management. Further, changes to a preference card may be mis-communicated or mis-recorded. These issues can lead to an inability to accurately charge payers correctly as well as accurately manage the surgical inventory present at a hospital. For at least these reasons, there is a need for improved systems and techniques for managing procedure preference information.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for management information update based on procedure preference information. According to an aspect, a method includes receiving procedure preference information and an associated identifier of a user. The method also includes updating management information for a procedure associated with the identifier of the user based on the procedure preference information.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a block diagram of an example system for management information update based on procedure preference information in accordance with embodiments of the present subject matter;

FIG. 2 is a screen display of an example interface provided by a mobile computing device for providing a user with interaction with a website in accordance with embodiments of the present subject matter;

FIG. 3 is a screen display of an example webpage provided by a web server in accordance with embodiments of the present subject matter;

FIG. 4 is a screen display of an example webpage provided by a web server for showing an operating room schedule view in accordance with embodiments of the present subject matter;

FIG. 5 is a screen display of an example webpage showing specific category item view for a selected procedure;

FIG. 6 is a flow chart of an example method for management information update based on procedure preference information in accordance with embodiments of the present subject matter; and

FIG. 7 is a flow chart of another example method for management information update based on procedure preference information in accordance with embodiments of the present subject matter.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

In accordance with embodiments of the present subject matter, a computing device or computing system may implement an application that makes it easier for surgeons and their proxies to communicate their surgical preferences. For example, the computing device may be mobile computing device, such as a smartphone or table computer, that implements a web-based, mobile-enabled application that facilitates communication of individual preferences of surgeons for surgical instruments, implants, equipment, supplies, instructions, and/or drugs in real time. Further, computing devices and computing systems disclosed herein can facilitate the accurate tracking of changed preferences and manage their impact on periop inventories over time. In this way, such preference management can improve patient care and enhance operating margins through increased operating room throughput, reduced inventory holding costs, and improved charge capture.

As referred to herein, the term “unspec codes” may be a supply category indicating that an item is “found.”

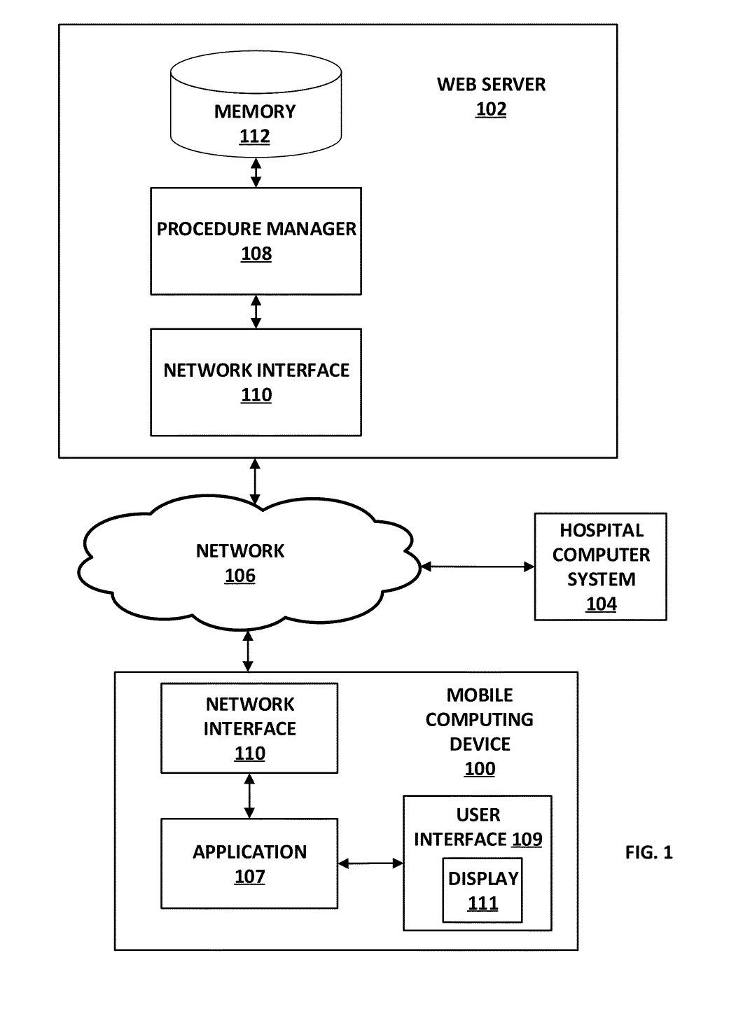

FIG. 1 illustrates a block diagram of an example system for management information update based on procedure preference information in accordance with embodiments of the present subject matter. It is noted that although multiple computing devices are shown in FIG. 1 as implementing the described functionality, one or more computing devices in any suitable configuration may be configured to implement the examples described herein. Referring to FIG. 1, the system includes a mobile computing device 100, a web server 102, and a hospital computer system 104 capable of communication via a network 106, such as the Internet. The mobile computing device 100 may be one of multiple computing devices configured to be communicatively connected to the web server 102 and the hospital computer system 104. For example, the mobile computing device 100 may run an application 107 residing thereon for allowing a user, such as a physician, to enter login information for accessing the web server 102 via the Internet. Other computing devices not shown in FIG. 1 may also have the same or similar application residing thereon for implementing functionality in accordance with the present subject matter. The web server 102 may provide a website for implementing the interface functionality described herein. The mobile computing device 100 may include a display controlled to present an interface such that the user can interact with the website.

The application 107 of the mobile computing device 100 may be implemented by hardware, software, firmware, or combinations thereof. For example, the application 107 may include one or more processors and memory. The mobile computing device 100 may also include a network interface 110 for communicating with the web server 102 and/or other computing devices via the network 106 or another network. Further, the mobile computing device 100 may include a user interface 109. The user interface 109 may include a touchscreen display 111 and other component (not shown for ease of illustration) for interfacing with a user.

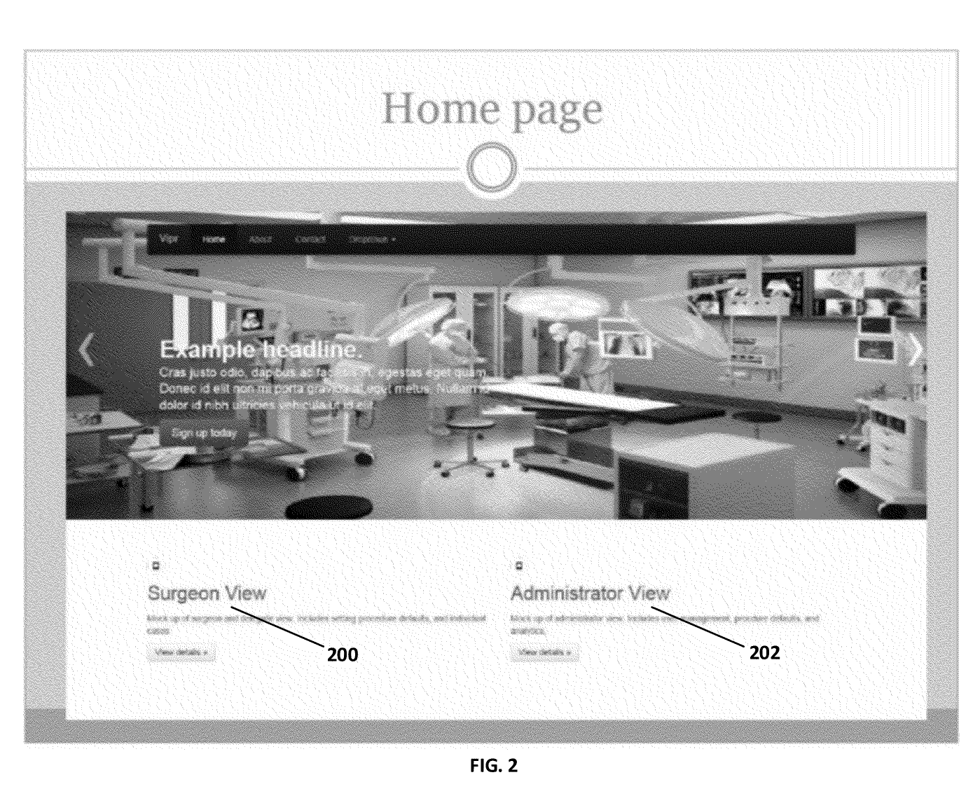

FIG. 2 illustrates a screen display of an example webpage in accordance with embodiments of the present subject matter. The webpage may be provided for access and interface by suitable computing devices, such as the mobile computing device 100 shown in FIG. 1. Further, for example, the webpage may be provided by suitable web servers, such as the web server 102 shown in FIG. 1. Referring to FIG. 2, the webpage provides a user with the ability to select either a “Surgeon View” button 200 or an “Administrator View” button 202. After clicking the “Surgeon View” button 200, a user's browser may be suitably controlled to display a webpage having two user-selectable buttons: “Cart Builder” and “OR Schedule.”

After selecting or “clicking” the “Cart Builder” button, the user's browser may be suitably controlled to display a webpage where s/he is given the opportunity to select the surgeon and procedure types (linked to the relevant CPT codes) for which s/he would like to upload and/or modify the preference cards for. These may be made to appear and/or be organized in various additional ways, including but not limited to by specialty, subspecialty, names of other surgeons at the same institution, procedure type, clusters of commonly billed for CPT codes, a downloaded of list of CPT codes, e.g., abstracted from historical billings and/or the like.

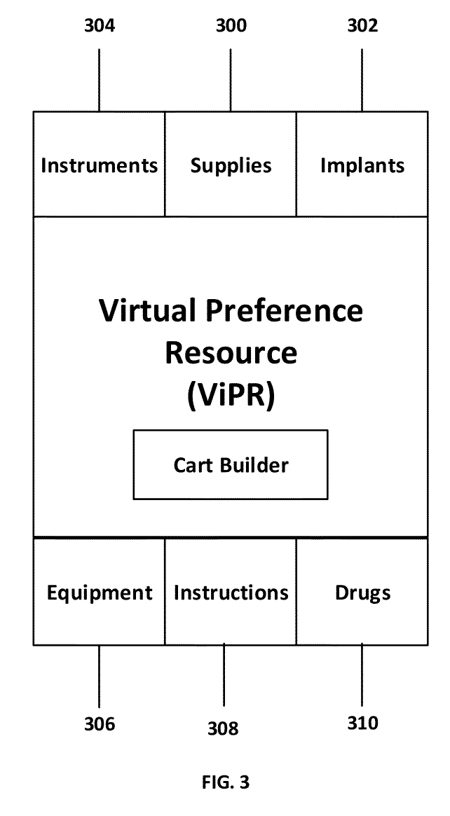

Subsequently, for the procedure type(s) selected, a “Virtual Cart” may be displayed on a webpage provided by the web server 102. FIG. 3 illustrates a screen display of an example interface provided by the mobile computing device 100 shown in FIG. 1 for providing a user with interaction with a website in accordance with embodiments of the present subject matter. The interface in this example is a webpage, although it may alternatively be any suitable interface.

Referring to FIG. 3, the interface includes a “Supplies” button 300, an “Implants” button 302, an “Instruments” button 304, an “Equipment” button 306, an “Instructions” button 308, and a “Drugs” button 310. The “Supplies” button 300 may be selected show this specific set of items contained in the associated preference card as well as items that are similar to the item listed on the preference card, and a part of the hospital's inventory, so that changes can be made quickly and efficiently. The “Implants” button 302 can be selected to show this specific set of items contained in the associated preference card as well as items that are similar to the item listed on the preference card, and a part of the hospital's inventory, so that changes can be made quickly and efficiently. The “Instruments” button 304 can be selected to show this specific set of items contained in the associated preference card as well as items that are similar to the item listed on the preference card, and a part of the hospital's inventory, so that changes can be made quickly and efficiently. The “Equipment” button 306 can be selected to show this specific set of items contained in the associated preference card as well as items that are similar to the item listed on the preference card, and a part of the hospital's inventory, so that changes can be made quickly and efficiently. The “Instructions” button 308 can be selected to show a common set of instructions contained in the associated preference card as it relates to certain CPT codes, so that changes can be made quickly and efficiently. The “Drugs” button 310 can be selected to show this specific set of items contained in the associated preference card as well as items that are similar to the item listed on the preference card, and a part of the hospital's inventory, so that changes can be made quickly and efficiently. Individual items can be displayed as pictures, names, link out to videos, have cost, inventory, and other information displayed as well. These buttons may be selected by touch in the case of a touchscreen display. This information may subsequently be stored and communicated as the preference card of record for this surgeon and procedure types.

The webpage may maintain and manage an operating room (OR) schedule. The schedule may be suitable presented on an electronic or computing device. Under “OR Schedule,” the surgeon (or his or her delegate) is allowed to see preference cards for specific cases and allow changes to the preference card for that procedure type to be made. The OR schedule may be presented subsequent to a user selecting or “clicking” an “OR Schedule” button. Subsequently, the user may be presented with the option of selecting a date or dates for which he or she would like to view the schedules. Users who may be delegates for multiple surgeons may be presented with a drop-down menu of the surgeons that the users are delegates for, before proceeding to select the date(s) which they would like to view. In an example, a default view that is presented may be the next time the surgeon is scheduled for surgery. Subsequently, the user may be presented with a webpage showing the OR schedule for the date selected.

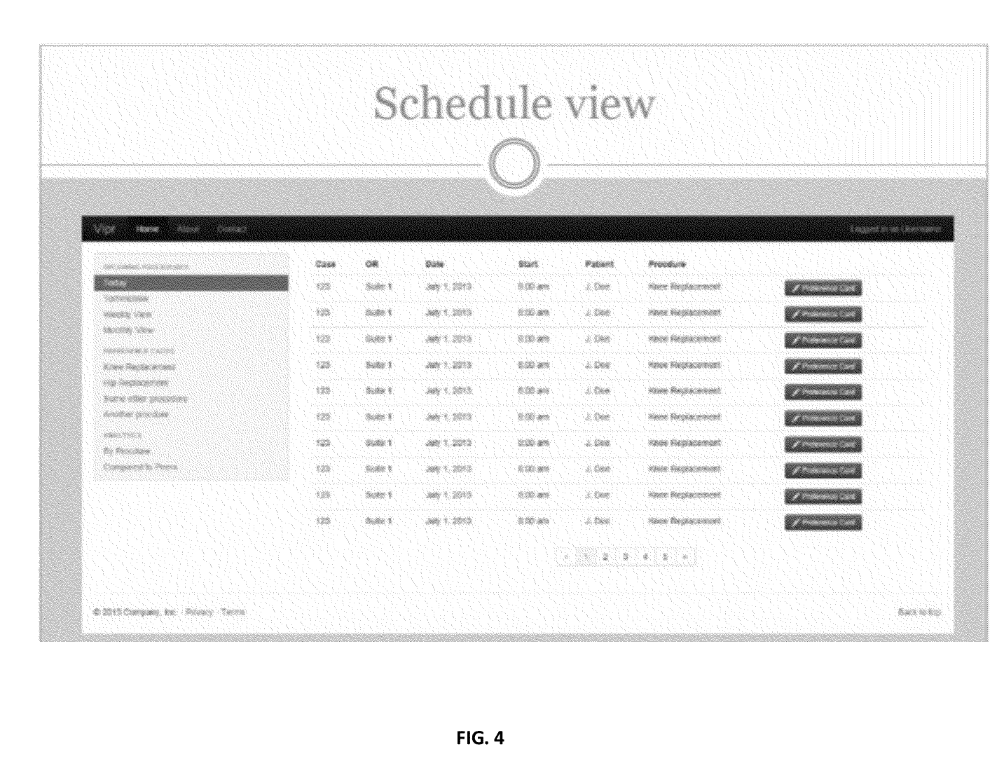

FIG. 4 illustrates a screen display of an example webpage that may be presented for showing an OR schedule view in accordance with embodiments of the present subject matter. For example, the webpage may be provided by the web server 102 to the mobile computing device 100 for presentation to a user. Alternatively, the webpage may be suitably presented by any other electronic device. Referring to FIG. 4, the webpage shows a surgical schedule for a physician on Jul. 1, 2013. For each scheduled procedure, the physician may select to view and/or edit a preference card associated with the procedure by selecting an associated button.

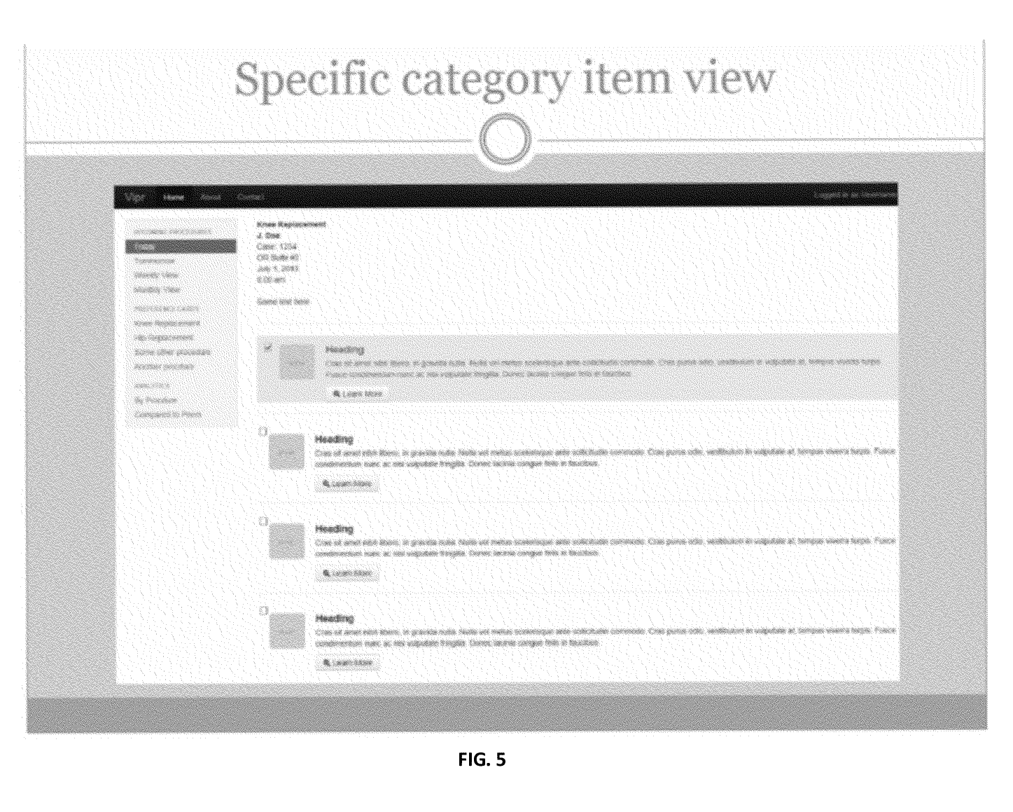

With continued reference to FIG. 4, by selecting or “clicking” on a case on the schedule, the user may subsequently be presented with a webpage showing a summary of surgeon-specific changes that reflect the preferences previously recorded by the “Cart Builder” feature described above for the procedure type/CPT codes for the scheduled surgery. This summary may be organized into the same categories as the “Virtual Cart” itself, which include, but are not limited to: instruments, implants, equipment, supplies, instructions, and drugs. The “Virtual Cart” may be linked both to the procedure type/CPT codes for the scheduled surgery as well as the specific patient who is scheduled for operation. FIG. 5 illustrates a screen display of an example webpage showing specific category item view for a selected procedure.

The user may have the option of making additional changes as well as confirming changes already made. By clicking on or hovering over each section, that section of the “Virtual Cart” may appear, either on the same page or a separate webpage. The “Virtual Cart” itself can be displayed as well, allowing the user to toggle between the summary of changes and the “Virtual Cart.”

Each change can be designated as one-time only; as permanent changes across all procedures of the same type; or automatically suggested for other patients with similar physical and non-physical characteristics (e.g., height, weight, sex, age, medical comorbidities, insurance coverage, or the like).

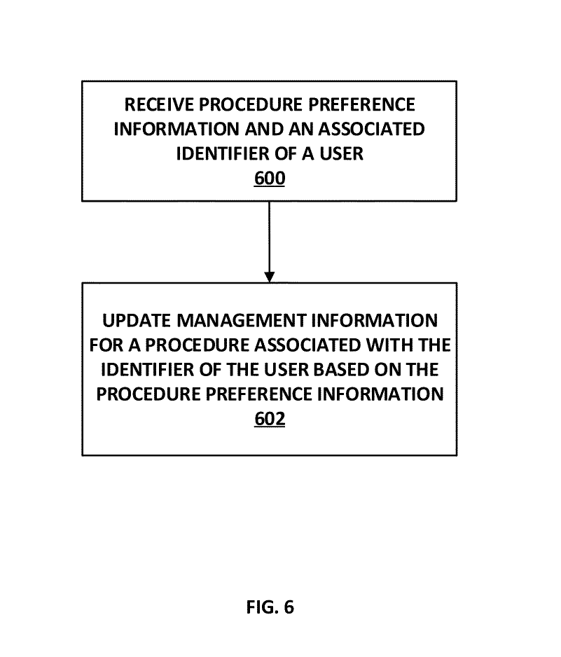

FIG. 6 illustrates a flow chart of an example method for management information update based on procedure preference information in accordance with embodiments of the present subject matter. It is noted that in this example the method is described as being implemented by the web server 102, although the method may be implemented by any suitable computing device. More particularly, the example method is implemented by a procedure manager 108, which may be hardware, software, firmware, or combinations thereof. For example, the procedure manager 108 may include one or more processors and memory including instructions for processing by the processor(s).

Referring to FIG. 6, the method includes receiving 600 procedure preference information and an associated identifier of a user. For example, the mobile computing device 100 may be used for generating updates to a preference card. In this example, a physician may interact with an application residing on the mobile computing device 100 to enter updates to the preference card on a webpage provided by the web server 102. The preference card may include procedure preference information for an upcoming surgery to be performed by the physician. Subsequently, the mobile computing device 100 may communicate the procedure preference information to the web server 102 via the network 106. The web server 102 may include a network interface 110 configured to communicate with the network 106 for receipt of the procedure preference information. The procedure manager 108 may store the procedure preference information in a memory 112.

The method of FIG. 6 includes updating 602 management information for a procedure associated with the identifier of the user based on the procedure preference information. Continuing the aforementioned example, the procedure manager 108 may manage a copy of the preference card stored in the memory 112. In response to receipt of the update information from the mobile computing device 100 the procedure manager 108 may update its copy of the preference card with the updated information. The preference card may be accessed by authorized computing devices, such as one or more servers among the hospital computer system 104.

In accordance with embodiments, a computing device may provide an interface for a user to select among different tools, equipment, and/or the like for identifying on a preference card. For example, a webpage presented on the mobile computing device 100 may present or display identification of multiple surgical tools and surgical equipment. As an example, surgical equipment or a surgical tool may be presented as a text description and/or an image. The user of the mobile computing device 100 may enter selection of one or more of the surgical tools and surgical equipment. Subsequently, the mobile computing device 100 may communicate the user selection to the web server 102 for update of a preference card with the user-selected surgical tools and/or surgical equipment. In another example, the user may identify one or more of the surgical tools and surgical equipment as being acceptable alternatives for the surgical procedure. Such information may be communicated to the web server 102 and indicated on the preference card as acceptable alternatives.

It is noted that a preference card may include management information such as, for example, a library of surgical equipment and surgical tools to be used in the surgical procedure. Procedure preference information may include identification of one of surgical equipment and a surgical tool for use in the surgical procedure. The update of management information may include updating the management information with the identified one of the surgical equipment and the surgical tool.

In accordance with embodiments, management information may include multiple item categories. For convenience to a user of a computing device such as the mobile computing device 100, the user interface may be user configurable for presentation of only a subset of the item categories for update by the user. For example, a physician may select that only a subset of tools is to be presented as options for selection for a surgical procedure. In this way, the physician does not have to sort through a full set of tools when selecting tools for a preference card.

It is noted that a system in accordance with the present disclosure may function in real time or near real time. For example, management information may be updated in real time. In this way, a current preference card may soon be provided to those accessing the preference card stored at the web server 102.

Management information or a preference card may be stored in a central database for access by users associated with the procedure and authorized to access the management information. For example, a preference card may be stored in memory 112 and accessible by authorized users operating the hospital computer system 104 and the mobile computing device 100. As an example, a computing device may communicate to the web server 102 a request for management information, such as a stored preference card. In response to receipt of an authorized request, the web server 102 may retrieve the requested preference card and communicate the preference card or other management information to the requesting computing device.

In accordance with embodiments, management information may be communicated to an accounting function. For example, information in one or more preference cards may be communicated to the hospital computer system 104 from the web server 102 for implementation of an accounting function; such as identifying surgical equipment and/or a surgical tool for determining billing for a surgical procedure.

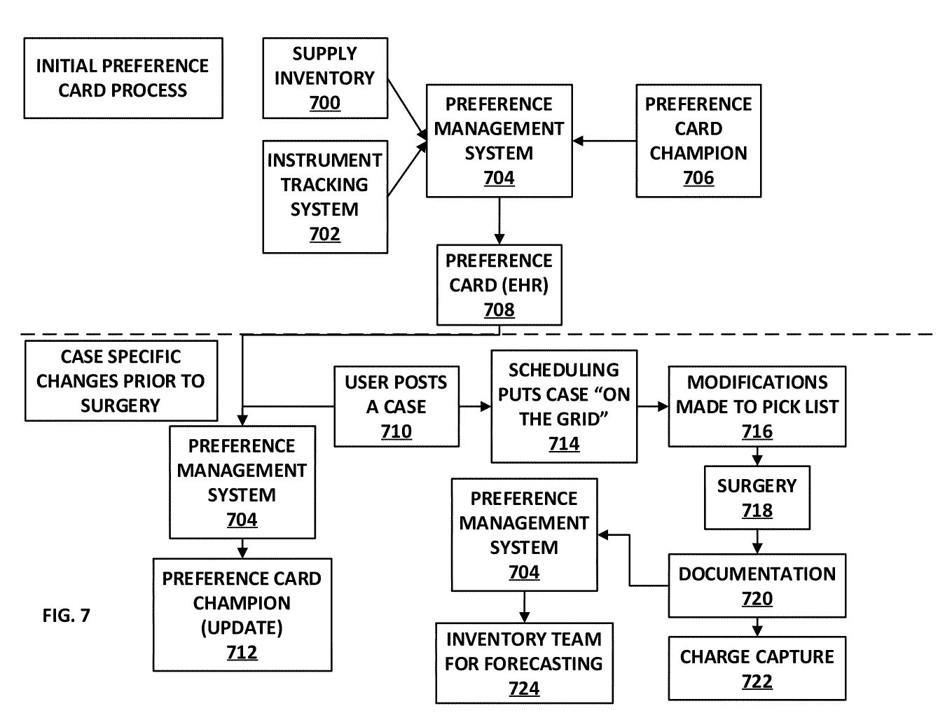

FIG. 7 illustrates a flow chart of another example method for management information update based on procedure preference information in accordance with embodiments of the present subject matter. It is noted that functionality of this example method may be implemented by the system shown in FIG. 1 or any other suitable system or electronic device. In an initial step, a healthcare provider may provide an inventory management system 700 and an instrument tracking system 702. Systems 700 and 702 may feed information into a preference management system 704 in accordance with the present disclosure. Herein, the preference management system 704 can track instruments left in inventory and which procedures they are being used. A preference card champion 706 at a healthcare provider can make updates to a preference card, specific to physician or specific to CPT code within the preference management system 704. Any changes made to data of a preference card 708 in the preference management system 704 may be transmitted to a data warehouse that holds the electronic preference cards. This may be held within the electronic health record of a healthcare provider. These steps may be referred to as an initial preference card process.

Subsequent to the initial preference card process, case specific changes prior to surgery may be implemented. There may be continual integration between the system that stores the preference and the system 704. A system user, either a healthcare provider or their designated surrogate, may post a case 710 in the scheduler of the system 704. Further, an update may be made by a preference card champion 712.

Subsequently, a user may make case specific changes to the preference card 708. For example, a case may be scheduled 714 and modifications made to a pick list 716. The system 704 may notify a sterile processing department and other similar departments responsible for building the case cart of the specific preference card that should be used for each surgery 718 of the day. Subsequently, the method includes documentation 720 of items used in surgery. Items that were documented as being used in surgery may be uploaded into the system 704 for analytic support for administrators. The method may also include charge capture 722 and communication of data for accurate forecasting by an inventory team 724.

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed subject matter. In the case of program code execution on programmable computers, the computer will generally include a processor, a storage medium readable by the processor (including volatile and non-volatile memory and/or storage elements), at least one input device and at least one output device. One or more programs may be implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed subject matter. When implemented on a general-purpose processor, the program code combines with the processor to provide a unique apparatus that operates to perform the processing of the presently disclosed subject matter.

Features from one embodiment or aspect may be combined with features from any other embodiment or aspect in any appropriate combination. For example, any individual or collective features of method aspects or embodiments may be applied to apparatus, system, product, or component aspects of embodiments and vice versa.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
at a computing device comprising a processor and memory:
receiving procedure preference information and an associated identifier of a user; and
updating management information for a procedure associated with the identifier of the user based on the procedure preference information.

2. The method of claim 1, wherein receiving procedure preference information comprises receiving the procedure preference information from another computing device via the Internet.

3. The method of claim 1, wherein the procedure is a surgical procedure, and wherein the procedure preference information comprises an identifier of one or more of surgical instruments, implants, supplies, equipment, instructions, and/or drugs for use in the surgical procedure.

4. The method of claim 3, wherein the management information comprises a preference card associated with the surgical procedure, identity of patient, procedure type, time and duration of the surgical case, CPT codes documented, and unspec codes.

5. The method of claim 1, wherein the computing device is a first computing device comprising a processor and memory, and
wherein the method further comprises, at a second computing device:
providing a user interface configured to receive user input;
receiving the procedure preference information; and
communicating the procedure preference information to the first computing device.

6. The method of claim 5, further comprising, at the second computing device:
presenting identification of a plurality of surgical tools and surgical equipment;
receiving user selection of one or more of the surgical instruments, implants, supplies, other equipment, instructions, and drugs; and
communicating the user selection to the first computing device.

7. The method of claim 6, further comprising, at the second computing device, identifying one or more of the surgical instruments, implants, supplies, other equipment, instructions, and drugs as being acceptable alternatives for the surgical procedure.

8. The method of claim 5, wherein the procedure is a surgical procedure,
wherein the management information comprises a library of surgical procedure, identity of patient, procedure type, time and duration of the surgical case, CPT codes documented, and unspec codes,
wherein the procedure preference information comprises identification of one of surgical equipment and a surgical tool for use in the surgical procedure, and
wherein updating management information comprises updating the management information with the identified one of the surgical equipment and the surgical tool.

9. The method of claim 8, further comprising using the second computing device to present information associated with the one of the surgical equipment and the surgical tool.

10. The method of claim 9, wherein the presented information comprises one of text description and an image of the surgical equipment.

11. The method of claim 9, wherein the presented information comprises one of text description and an image of the surgical tool.

12. The method of claim 5, wherein the management information comprises a plurality of item categories, and
wherein the user interface is user configurable for presentation of only a subset of the item categories for update by the user.

13. The method of claim 1, further comprising storing the management information in a central database for access by users associated with the procedure and authorized to access the management information.

14. The method of claim 1, wherein the computing device is a first computing device, and wherein the method further comprises, at the first computing device:
receiving a request from a second computing device for the management information; and
communicating the management information to the second computing device.

15. The method of claim 16, further comprising communicating an identifier of one or more of surgical equipment and a surgical tool to an accounting function for determining billing for a surgical procedure.

16. A system comprising:
a processor and memory; and
a procedure manager configured to:
receive procedure preference information and an associated identifier of a user; and
update management information for a procedure associated with the identifier of the user based on the procedure preference information.

17. The system of claim 16, wherein the procedure manager is configured to receive the procedure preference information from another computing device via the Internet.

18. The system of claim 16, wherein the procedure is a surgical procedure, and wherein the procedure preference information comprises an identifier of one or more of surgical equipment and a surgical tool for use in the surgical procedure.

19. The system of claim 18, wherein the management information comprises a preference card associated with the surgical procedure.

20. The system of claim 16, further comprising a first computing device comprising the procedure manager and the processor and memory, and
wherein the system further comprises a second computing device configured to:
provide a user interface configured to receive user input;
receive the procedure preference information; and
communicate the procedure preference information to the first computing device.
